(19) United States
(12) Patent Application Publication
(10) Pub. No.: US 2006/0262936 A1
(43) Pub. Date: Nov. 23, 2006

(54) Virtual surround decoder apparatus

(75) Inventor: Koichi Sato, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Tendo-shi (JP)

(21) Appl. No.: 11/432,662

(22) Filed: May 12, 2006

(30) Foreign Application Priority Data
May 13, 2005 (JP) 2005-141825
May 13, 2005 (JP) 2005-141828

(51) Int. Cl. H04R 5/00

(52) U.S. Cl. 381/22

(57) ABSTRACT

A virtual surround decoder apparatus includes a matrix surround decoder which generates multi-channel source signals from 2-channel input source signals, a virtual surround decoder which generates the 2-channel virtual surround signals from the multi-channel source signals, and a level correcting unit which corrects the levels of the virtual surround signals. The levels of the virtual surround signals outputted from the virtual surround decoder are corrected by the level correcting unit. Thereby, when an attenuation process is executed in the matrix surround decoder, the levels of the virtual surround signals can be corrected in order to offset the attenuation amount, and S/N of a reproduction sound can be improved.

### BACKGROUND OF THE INVENTION

1. Field of the Invention

The present invention relates to a virtual surround decoder apparatus.

2. Description of Related Art

Recently, there is developed a matrix surround decoding technique of expanding a 2-channel(ch) stereo source to a 5.1 ch multi-channel source to reproduce it. Acoustic signals of the multi-channel source are generated from the 2 ch source signals of normal stereo recording, such as a CD, by using a matrix surround decoder, and sound reproduction is performed. Thereby, a stereo acoustic effect can be realized.

Generally, a multi-channel reproduction apparatus such as an AV amplifier and a DVD player generates a source (sound) signal of each of left and right front channels, a center channel, left and right surround channels and a sub-woofer channel from digital audio data recorded on a DVD (Digital Versatile Disc) and a CD (Compact Disc) recorded by the multi-channel recording. The multi-channel reproduction apparatus outputs the multi-channel source signals to 5 or more speakers arranged around a listener, respectively. Thereby, a stereo acoustic field with so much presence is created.

Meanwhile, when the stereo acoustics reproduced by the multi-channel reproduction apparatus is listened by using headphones, it becomes necessary to synthesize the multi-channel source signals generated from the digital audio data to generate the 2 ch source signals. Synthesizing the multi-channel source signals to generate the 2 ch source signals in this manner is referred to as “stereo downmix”. If the 2 ch source signals obtained by the stereo downmix are reproduced through the left and right headphones, the listener can listen to the stereo acoustics with so much presence similar to a surround system through the headphones. The headphones are also referred to as “surround headphones”.

Conversion from the multi-channel source signals to source signals of smaller number of channels is referred to as “virtual surround decoding process”, and the signal thus obtained is referred to as “virtual surround signal”. The above stereo downmix is an example of the virtual surround decoding process.

The examples of the above stereo downmix and the above surround headphones are disclosed in Japanese Patent Applications Laid-open under No. 2003-333699 and No. 2003-333700.

In order to prevent clipping of a signal level in the matrix process, the above matrix surround decoder normally executes an attenuation process of 3 dB to each of the inputted signals and subsequently executes the matrix surround decoding process. Therefore, when the virtual surround decoding process such as the stereo downmix is executed to the multi-channel source signals obtained by the matrix surround decoding process in order to realize the surround headphones in the above-mentioned manner, since the signal levels are attenuated before the matrix surround decoding process, the signal levels of the obtained virtual surround signals are also attenuated, for example. Thereby, S/N of the reproduction sound problematically worsens.

The virtual surround decoder executing the above-mentioned virtual surround process synthesizes the multi-channel source signals with predetermined coefficients to generate the virtual surround signals. At this time, in order to prevent the clipping of the synthesized signal level, the attenuation process of a predetermined level is executed to the multi-channel source signals, and the synthesizing process is subsequently executed.

However, even when the input source signals are not the multi-channel signals but monophonic signals or stereo signals, the virtual surround decoder executes the above-mentioned attenuation process. Therefore, when the input source signal are the monophonic signals or the stereo signals, the S/N of the outputted virtual surround signal problematically worsens.

### SUMMARY OF THE INVENTION

The present invention has been achieved in order to solve the above problem. It is an object of this invention to improve S/N when the virtual surround decoding process is executed to multi-channel signals obtained by the matrix surround decoding process to generate the virtual surround signals, or when the virtual surround decoding process is executed to the monophonic signals and the stereo signals.

According to one aspect of the present invention, there is provided a virtual surround decoder apparatus including: a matrix surround decoder which generates multi-channel source signals from 2-channel input source signals; a virtual surround decoder which generates virtual surround signals from the multi-channel source signals; and a level correcting unit which corrects levels of the virtual surround signals.

The above virtual surround decoder apparatus includes the matrix surround decoder generating the multi-channel source signals from the 2-channel input source signals. The 2-channel input source signals may be surround-encoded stereo signals or normal unencoded stereo signals, for example. In addition, the multi-channel source signals include left and right front signals, a center signal and left and right surround signals, for example. The virtual surround decoder arranged subsequently to the matrix surround decoder generates the virtual surround signals from the multi-channel source signals. The virtual surround decoder may be a stereo downmix processor in a Dolby headphone system, for example. The virtual surround signals may be 2-channel surround headphone output signals for headphone reproduction, for example. The level correcting unit executes the level correction of the virtual surround signals. Thereby, even when the attenuation process is executed to the input source signals in the matrix surround decoder, the level correction can be executed to the virtual surround signals to offset the attenuation amount, and the S/N of the reproduction sound is improved.

In a manner of the above virtual surround decoder apparatus, the matrix surround decoder may include an attenuation processing unit which attenuates the 2-channel input source signals by a predetermined level and an operating unit which executes a matrix operation of the 2-channel input source signals after the attenuation process to generate the multi-channel source signals, and the level correcting unit may correct the levels of the virtual surround signals by the predetermined level.

In this manner, the attenuation process is executed to the 2-channel input source signals in advance of the matrix operation in the virtual surround decoder. Therefore, in the virtual surround decoder, the levels of the virtual surround signals are increased by the attenuation amount, and hence the S/N can be improved.

According to another aspect of the present invention, there is provided a virtual surround decoder apparatus including: a multi-channel decoder which outputs source signals of one of a plural kinds including multi-channel signal based on input source signals; a virtual surround decoder which generates virtual surround signals from the source signals outputted from the multi-channel decoder; a determining unit which determines the kind of the source signals outputted from the multi-channel decoder; and a level correcting unit which corrects the levels of the virtual surround signals based on a determination result by the determining unit.

The above virtual surround decoder apparatus includes the multi-channel decoder generating the source signals of one of plural kinds including the multi-channel signal from the input source signals. The input source signals are the monophonic signals, the surround-encoded stereo signals or the normal unencoded stereo signals, for example. The multi-channel source signals include the left and right front signals, the center signal and the left and right surround signals, for example.

The virtual surround decoder arranged subsequently to the multi-channel decoder generates the virtual surround signals from the source signals outputted from the multi-channel decoder. The virtual surround decoder may be the stereo downmix processor of the Dolby headphones system, and the virtual surround signals may be the 2-channel surround headphone output signals for the headphone reproduction, for example.

The kind of the source signals outputted from the multi-channel decoder is determined by the determining unit. Based on the determination result by the determining unit, the levels of the virtual surround signals are corrected. Hence, in accordance with the kind of the source signals supplied from the multi-channel decoder to the virtual surround decoder, the levels of the virtual surround signals are appropriately corrected, and thereby the S/N of the reproduction sound is improved.

In a manner of the above virtual surround decoder apparatus, the determining unit may determine whether the source signals outputted from the multi-channel decoder are monophonic signals, stereo signals or multi-channel signals, and the level correcting unit may execute level correction when the source signals outputted from the multi-channel decoder are the monophonic signals or the stereo signals.

When the source signals inputted to the virtual surround decoder are the monophonic signals or the stereo signals, the levels of the outputted virtual surround signals are attenuated by the attenuation process in the virtual surround decoder, and the S/N worsens. Therefore, as described above, when the source signals inputted to the virtual surround decoder are the monophonic signals or the stereo signals, the level correction is executed.

In another manner of the above virtual surround decoder apparatus, the virtual surround decoder may include an attenuation processing unit which attenuates the source signals outputted from the multi-channel decoder by a predetermined attenuation level, and a synthesizing unit which synthesizes the attenuated source signals to generate the virtual surround signals, and the level correcting unit may execute correction of increasing the levels of the virtual surround signals by a correction level corresponding to the predetermined attenuation level.

When the source signals inputted to the virtual surround decoder are the multi-channel source signals, the signal levels may clip in the synthesizing process. Therefore, in advance of the synthesizing process, the attenuation process of the predetermined level is executed. Meanwhile, when the source signals inputted to the virtual surround decoder are the monophonic signals or the stereo signals, the signal levels never clip. Rather, since the S/N is decreased by the attenuation process, the level correcting unit executes the correction of increasing of the level of the virtual surround signals in accordance with the attenuation amount by the attenuation process.

In a preferred example, the correction level may be equal to the predetermined attenuation level. Namely, when the attenuation of XdB is executed in the attenuation process in the virtual surround decoder, the level correcting unit executes the level correction of increasing the signal level by XdB. Thereby, it can be prevented that the S/N of the monophonic signals or the stereo signals decreases by the attenuation process.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram showing a configuration of a virtual surround decoder apparatus according to an embodiment of the present invention.

FIG. 2 is a block diagram showing a configuration of the Dolby prologic II decoder as an example of a matrix surround decoder.

FIG. 3 is a table showing a functional characteristic of an output mode of the matrix surround decoder.

FIG. 4 is a block diagram showing a configuration of the virtual surround decoder apparatus according to another embodiment of the present invention.

### DETAILED DESCRIPTION OF THE PREFERRED EMBODIMENTS

The preferred embodiments of the present invention will now be described below with reference to the attached drawings.

### First Embodiment

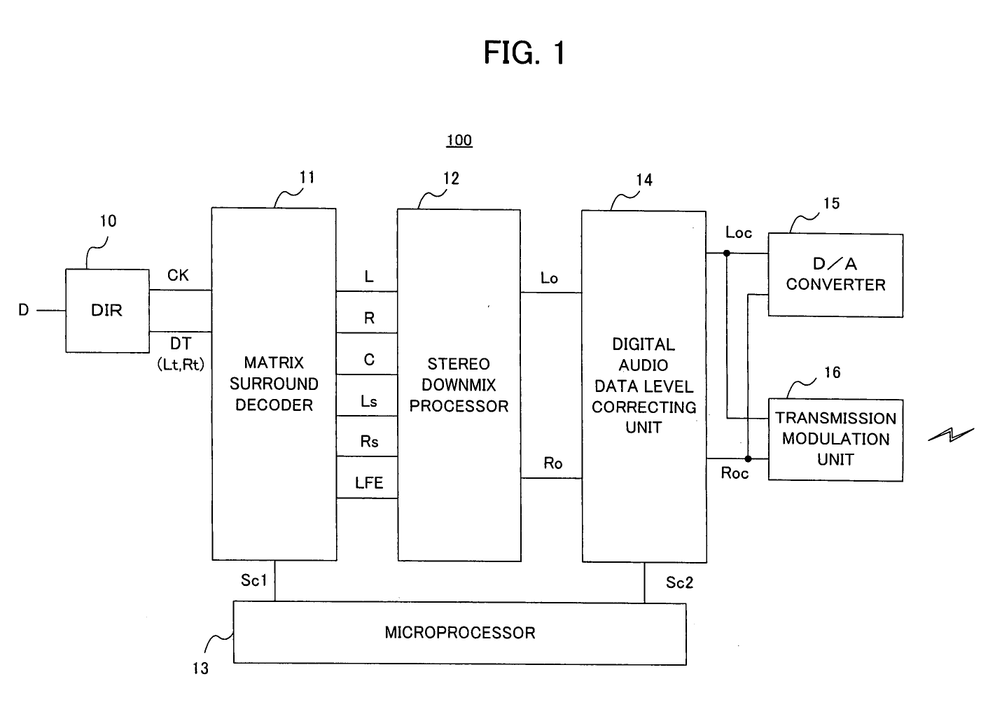

FIG. 1 is a block diagram showing a configuration of the virtual surround decoder apparatus according to a first embodiment of the present invention. In FIG. 1, a virtual surround decoder apparatus 100 includes a digital audio interface receiver (DIR) 10, a matrix surround decoder 11, a stereo downmix processor 12, a microprocessor 13, a digital audio data level correcting unit (hereinafter, simply referred to as “level correcting unit”) 14, a D/A converter 15 and a transmission modulation unit 16.

2 ch digital audio data D outputted from various kinds of audio apparatuses serving as input sources is inputted to the DIR 10. The 2 ch digital audio data is the surround-encoded stereo signal or the normal unencoded stereo signal.

The DIR 10 extracts a clock CK and data DT from the digital audio data D and demodulates them to output them to the matrix surround decoder 11. The data DT include left channel data Lt and right channel data Rt.

According to a matrix surround decoding technique, the matrix surround decoder 11 generates, from the 2 ch data DT inputted from the DIR 10, 5.1 ch signals including a left front signal L, a right front signal R, a center signal C, a left surround signal Ls, a right surround signal Rs and a sub-woofer signal LFE in accordance with the clock CK, and outputs them to the stereo downmix processor 12.

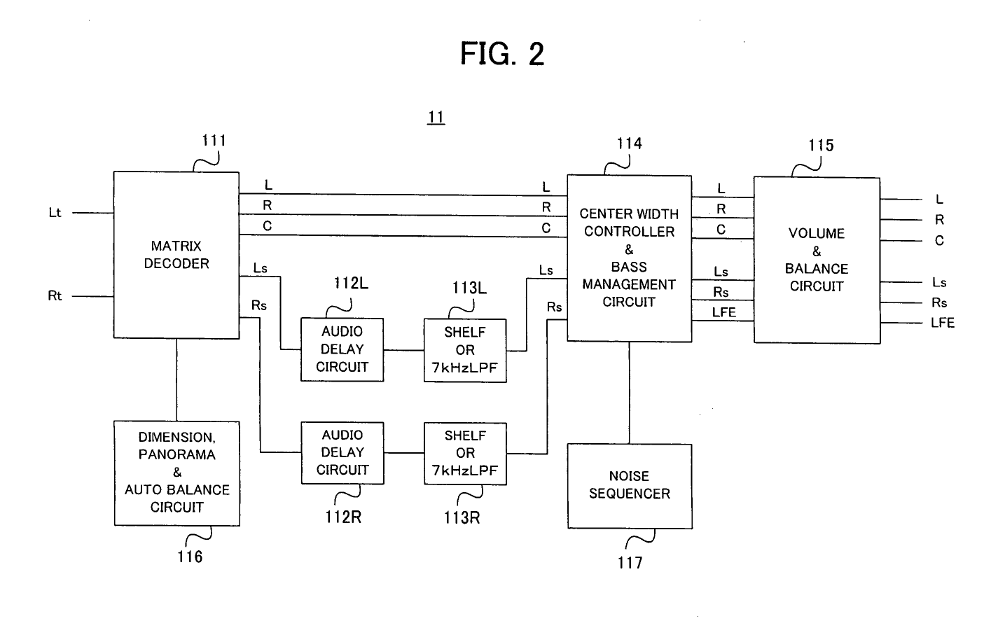

Now, the matrix surround decoder 11 will be explained in detail. As an example of the matrix surround decoder 11, FIG. 2 shows a block diagram of a configuration of a Dolby prologic II decoder. As shown in FIG. 2, the matrix surround decoder 11 includes a matrix decoder 111, audio delay circuits 112L and 112R, shelf-or-7 kHz LPFs 113L and 113R, a center width controller and bass management circuit 114, a volume and balance circuit 115, a dimension, panorama and auto balance circuit 116 and a noise sequencer 117.

From the 2 ch data Dt(Lt,Rt) inputted from the DIR 10, the matrix decoder 111 extracts main 5-channel signals, i.e., the front signals L and R, the center signal C and the surround signals Ls and Rs, to output them. Concretely, the matrix decoder 111 generates the main 5-channel signals by steering logic (direction emphasizing technique) executing a matrix operation based on the inputted 2 ch data Lt and Rt.

The front signals L and R and center signal C thus generated are inputted to the center width controller and bass management circuit 114. Meanwhile, the surround signals Ls and Rs are supplied to the audio delay circuits 112L and 112R, respectively. The surround signals Ls and Rs are supplied to the center width controller and the bass management circuit 114 via the audio delay circuits 112L and 112R and the shelf-or-7 kHz LPFs 113L and 113R, respectively.

As need arises, the center width controller and bass management circuit 114 executes the center width control. At the same time, the center width controller and bass management circuit 114 generates the sub-woofer signal LFE, and supplies the main 5-channel signals and the sub-woofer signal LFE to the volume and balance circuit 115. The volume and balance circuit 115 adjusts the volume of the signal of each channel and the balance between the signals to output the signal of each channel.

The dimension, panorama and auto balance circuit 116, which is connected to the matrix decoder 111, executes dimension control and panorama control of the matrix decoder 111 and switching of an auto balance mode. In addition, the noise sequencer 117 is used to outputs noise from the speaker of each of the channels L, C, R, Ls and Rs in sequence, thereby to adjust the sound volume of speaker of each channel and adjust the distance of the speaker (i.e., adjusting of the delay time).

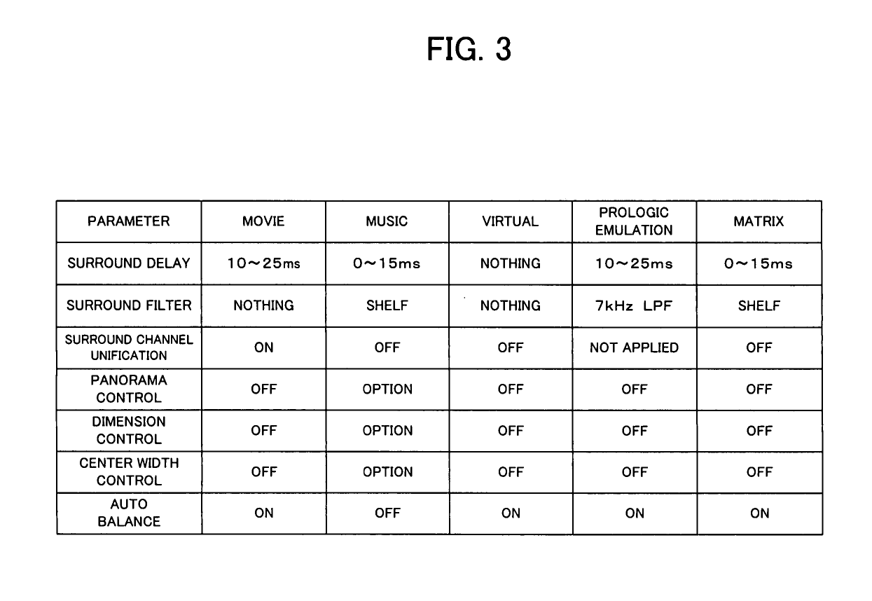

The Dolby prologic II decoder includes a virtual mode, a prologic emulation mode and a matrix mode in addition to a movie mode suitable for reproduction of a movie source and the normal 2 ch source signals and a music mode suitable for reproduction of stereo music signals. FIG. 3 shows functional characteristics of the respective modes.

In FIG. 3, “surround delay” is a delay given to each of the surround signals Ls and Rs by the audio delay circuits 112L and 112R, and the amount of delay is different for each mode. “Surround filter” indicates a filter process executed by the shelvf-or-7 kHz LPFs 113L and 113R arranged subsequently to the audio delay circuits 112L and 112R. A shelf filter is used in the music mode and the matrix mode, and the 7 kHz LPF is used in the prologic emulation mode. “Surround channel unification” is used in the movie mode, in which the surround speakers are set to be in phase with each other.

“Panorama control” expands the front stereo image to the surround speakers and generates a wrap effect by a side surface sound image. “Dimension control” shifts the sound field to the front side or the surround side (rear side) and adjusts the level difference between the front side and the rear side. “Center width control” distributes the center signal components to the left and right speakers of the front side so that the center signal components do not concentrate on the center. “Auto balance” automatically controls the balance between the left and right speakers of the front side based on the center signal C. The panorama control, the dimension control and the auto balance control are executed by the dimension, panorama and auto balance circuit 116 shown in FIG. 2. Additionally, the center width control is executed by the center width controller and bass management circuit 114.

Returning to FIG. 1, the stereo downmix processor 12 synthesizes the left front signal L, the right front signal R, the center signal C, the left surround signal Ls, the right surround signal Rs and the sub-woofer signal LFE based on a downmix coefficient preset in advance, and thereby generates 2 ch surround headphone output signals Lo and Ro. An example of the signal synthesizing equation by the stereo downmix processor will be shown below.
Lo=α (L+0.707C+Ls+LFE)
Ro=α (R+0.707C+Rs+LFE) (1)

“α”, which is referred to as “attenuation coefficient”, is used to prevent that gain of the surround headphone output signals Lo and Ro becomes larger than “1” and the reproduction sound from the headphones is clipped when the signal level of each of the channels simultaneously becomes large. The surround headphone output signals Lo and Ro thus obtained are supplied to the level correcting unit 14. The process by the stereo downmix processor corresponds to the virtual surround process, and each of the surround headphone output signals Lo and Ro thus obtained corresponds to the virtual surround signal.

The microprocessor 13 obtains information of a sampling frequency (FS) included in the digital audio data D from the DIR 10. Based on the obtained information of the sampling frequency, the microprocessor 13 determines a kind of input source. Based on the determined result, the microprocessor 13 supplies, to the matrix surround decoder 11, a mode control signal Sc1 indicating any one of the above-mentioned modes (e.g., the movie mode and the music mode). Even when a user manually chooses the mode, the microprocessor 13 supplies, to the matrix surround decoder 11, the mode control signal Sc1 indicating the mode. Based on the mode control signal Sc1, the matrix surround decoder 11 executes each of the functions explained with reference to FIG. 3.

In addition, the microprocessor 13 supplies a correction control signal Sc2 to the level correcting unit 14. The level correcting unit 14 corrects the levels of the surround headphone output signals Lo and Ro on the basis of the correction controlling signal Sc2 given by the microprocessor 13. The level correction amount indicated by the correction control signal Sc2 basically depends on the attenuation process executed by the matrix surround decoder 11. The matrix surround decoder 11 executes the attenuation process of attenuating the levels of the left and right channel data Lt and Rt by a predetermined attenuation amount (e.g., 3 dB) in advance of the matrix process in order to prevent occurrence of the signal level clipping in the matrix process. Thus, the surround headphone output signals Lo and Ro obtained by the stereo downmix processor 12 are attenuated by the predetermined level, as compared with the inputted audio data DT (Lt,Rt), and the S/N is decreased by the amount of the predetermined level. Hence, the microprocessor 13 supplies, to the level correcting unit 14, the correction control signal Sc2 indicating the level correction amount (3 dB in the above example) corresponding to the amount attenuated by the matrix surround decoder 11. Thereby, the levels of the surround headphone output signals Lo and Ro are corrected by the same amount, and the S/N of the reproduction sound is improved. The corrected output signal Loc and Roc are supplied to the D/A converter 15 and the transmission modulation unit 16, respectively.

The D/A converter 15 is connected to the speakers via an amplifier (not shown), and the surround headphone output signals Loc and Roc are reproduced. In addition, the transmission modulation unit 16 is a modulating unit of the digital audio data transmitted to wireless headphones, and the modulated signal is transmitted to the wireless headphones (not shown). As the transmission modulation, FM modulation and predetermined digital modulation can be used, for example.

As described above, the virtual surround decoder apparatus 100 includes the matrix surround decoder 11 generating the multi-channel source signals from the 2-channel input source signals, the stereo downmix processor 12 generating the surround headphone output signals from the multi-channel source signals, and the level correcting unit 14 correcting the level of the surround headphone output signals. Therefore, even when the attenuation process is executed to the input source signals in the matrix surround decoder, the level correction can be executed to the surround headphone output signals to offset the attenuation amount, and the S/N of the reproduction sound is improved. Further, since the S/Ns of the surround headphone output signals Lo and Ro are ensured, the S/N in the transmission process from the transmission modulation unit 16 to the wireless headphones can be also ensured.

(Modification)

In the above-mentioned example, the correction amount by the level correcting unit 14 is prescribed as the attenuation amount (3 dB in the above-mentioned example) of the attenuation process executed by the matrix surround decoder 11. In addition, the level correction amount by the level correcting unit 14 may be further determined in view of the attenuation amount by the stereo downmix processor 12, i.e., the value of the attenuation coefficient α. Concretely, the level correction amount by the level correcting unit 14 may be set to the sum of the predetermined attenuation amount executed by the matrix surround decoder 11 and the attenuation amount (attenuation coefficient α) by the stereo downmix processor 12.

### Second Embodiment

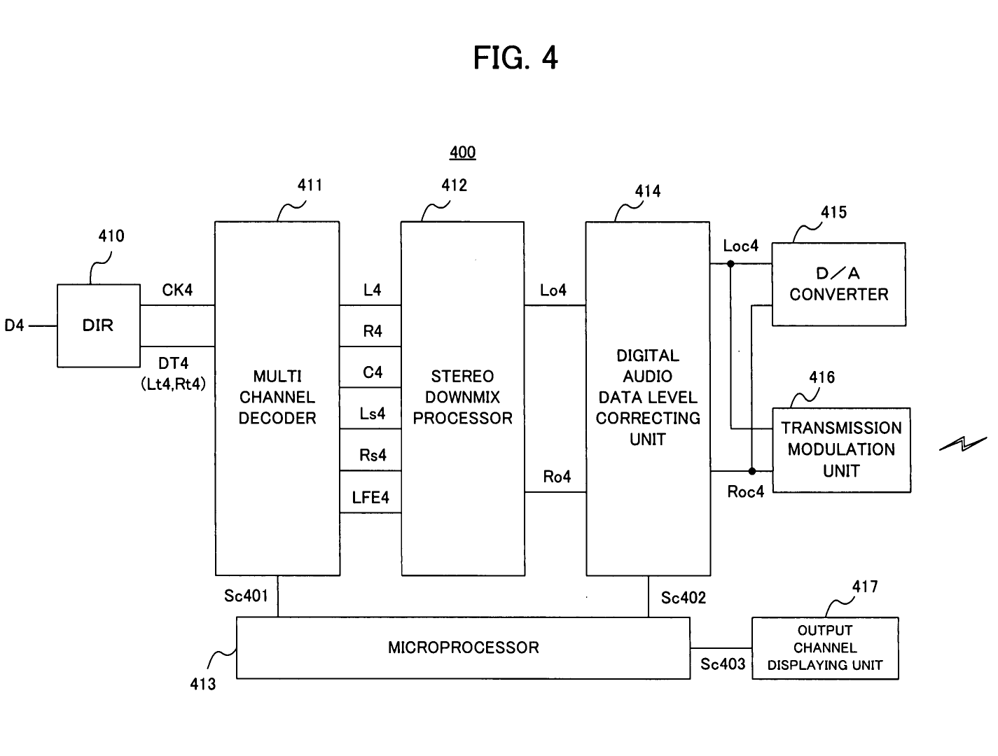

FIG. 4 is a block diagram showing the configuration of the virtual surround decoder apparatus according to a second embodiment of the present invention. In FIG. 4, a virtual surround decoder apparatus 400 includes a digital audio interface receiver (DIR) 410, a multi-channel decoder 411, a stereo downmix processor 412, a microprocessor 413, a digital audio data level correcting unit (hereinafter, simply referred to as “level correcting unit”) 414, a D/A converter 415, a transmission modulation unit 416 and an output channel displaying unit 417.

Digital audio data D4 outputted from various kinds of audio apparatuses serving as input sources is inputted to the DIR 410. The digital audio data D4 is the monophonic signal, the surround-encoded stereo signal or the normal unencoded stereo signal.

The DIR410 extracts a clock CK4 and data DT4 from the digital audio data D4 and demodulates them to output them to the multi-channel decoder 411.

In accordance with the clock CK4, the multi-channel decoder 411 generates the 5.1 ch signals including a left front signal L4, a right front signal R4, a center signal C4, a left surround signal Ls4, a right surround signal Rs4 and a sub-woofer signal LFE4 from the data DT4 inputted from the DIR 410, and outputs them to the stereo downmix processor 412. When the digital audio data D4 is the monophonic signal, it is outputted from the center signal C4.

The stereo downmix processor 412 synthesizes the left front signal L4, the right front signal R4, the center signal C4, the left surround signal Ls4, the right surround signal Rs4 and the sub-woofer signal LFE4 on the basis of the downmix coefficient preset in advance to generate 2 ch surround headphone output signals Lo4 and Ro4. An example of the signal synthesizing equation by the stereo downmix processor will be shown below.
Lo4=α4 (L4+0.707C4+Ls4+LFE4)
Ro4=α4 (R4+0.707C4+Rs4+LFE4) (2)

“α4”, which is referred to as the attenuation coefficient, is used to prevent that gain of the surround headphone output signals Lo4 and Ro4 becomes larger than “1” and the reproduction sound from the headphones is clipped when the signal level of each of the channels simultaneously becomes large. When the attenuation coefficient α4 is small (i.e., the attenuation rate is large), the levels of the surround headphone output signals Lo4 and Ro4 become small, and the S/N worsens. Meanwhile, when the attenuation coefficient α4 is large (i.e., the attenuation rate is small), the reproduction sound by the surround headphone output signals Lo4 and Ro4 may be problematically clipped. Therefore, when the surround headphone output signals Lo4 and Ro4 are generated from the multi-channel signals, the multi-channel signals are attenuated by the predetermined level determined in advance, i.e., by the attenuation coefficient α4.

However, as understood by the equation (2), when the input source signal is not the multi-channel signal but the stereo signal, there is no component of the center signal C4, the surround signals Ls4 and Rs4 and the sub-woofer signal LFE4. When the input source signal is not the multi-channel signal but the monophonic signal, there is no component other than the center signal C4. Thus, the levels of the surround headphone output signals Lo4 and Ro4 simply become levels obtained by attenuating the input signal by the attenuation coefficient α4, and the levels decrease as compared with the input source signal. Hence, the S/N of the reproduction sound of the surround headphone output signals Lo4 and Ro4 decreases.

In this view, when the input source signal is the monophonic signal or the stereo signal, the level correcting unit 414 executes the correction of increasing the levels of the surround headphone output signals Lo4 and Ro4 by the levels corresponding to the attenuation coefficient α4. Namely, the surround headphone output signals Lo4 and Ro4 generated by the stereo downmix processor 412 are supplied to the level correcting unit 414. The process by the stereo downmix processor corresponds to the virtual surround process, and the surround headphone output signals Lo4 and Ro4 thus obtained correspond to the virtual surround signal.

Now, the level correction by the level correcting unit 414 will be explained in detail. The multi-channel decoder 411 determines the kind of the source signal outputted to the stereo downmix processor 412 from the multi-channel decoder 411 based on the data DT4 included in the digital audio data D4 inputted from the DIR 410. Namely, the multi-channel decoder 411 determines whether the source signal supplied to the stereo downmix processor 412 is the monophonic signal, the stereo signal or the multi-channel signal. Concretely, the multi-channel decoder 411 determines the kind of the source signal based on each of the source signals generated in itself and supplied to the stereo downmix processor. When the source signal supplied to the stereo downmix processor 412 is the multi-channel signal, each of the channel signals L4, R4, C4, Ls4, Rs4 and LFE4 includes all the components. Meanwhile, when the source signal supplied to the stereo downmix processor 412 is the stereo signal, only the left front signal L4 and the right front signal R4 exist, and the components of the other channel signals C4, Ls4, Rs4 and LFE4 become 0. When the source signal supplied to the stereo downmix processor 412 is the monophonic signal, the components of the signals other than the center signal C4 become 0. In this manner, the multi-channel decoder 411 determines whether the source signal supplied to the stereo downmix processor 412 is the monophonic signal, the stereo signal or the multi-channel signal, and supplies output channel information Sc401 showing a result thereof to the microprocessor 413. When the source signal is a non-PCT signal such as a Dolby digital signal, DTS and AAC, the signal includes the output channel information, which is detected by the multi-channel decoder 411.

Based on the output channel information Sc401, the microprocessor 413 generates the correction control signal Sc402 to supply it to the level correcting unit 414. Concretely, when the source signal supplied to the stereo downmix processor 412 from the multi-channel decoder 411 is the monophonic signal or the stereo signal, the correction control signal Sc402 indicates the correction amount of a predetermined level. When the source signal is the multi-channel signal, the level correction amount is 0.

The level correction amount indicated by the correction control signal Sc402 basically depends on the attenuation amount of the attenuation process executed by the stereo downmix processor 412. As described above, when the stereo downmix processor 412 attenuates the input source signal by the attenuation coefficient α4, the correction amount of the predetermined level becomes the correction amount to increase the levels of the surround headphone output signals Lo4 and Ro4 by the level corresponding to the attenuation coefficient α4. As a typical example, when the stereo downmix processor 412 attenuates each of the input source signals by the amount of XdB by the attenuation coefficient α4, the correction amount of the predetermined level becomes the amount to increase the levels of the surround headphone output signals Lo4 and Ro4 by the amount of XdB, respectively. As a result, as described above, it can be prevented that the S/Ns of the surround headphone output signals Lo4 and Ro4 problematically decrease due to the attenuation process of the stereo downmix processor 412.

The microprocessor 413 supplies the correction control signal Sc402 to the level correcting unit 414. Based on the correction control signal Sc402 given by the microprocessor 413, the level correcting unit 414 corrects the levels of the surround headphone output signals Lo4 and Ro4. Concretely, when the source signal supplied to the stereo downmix processor 412 from the multi-channel decoder 411 is the monophonic signal or the stereo signal, the level correcting unit 414 executes the correction by the above-mentioned correction amount of the predetermined level. Meanwhile, when the source signal is the multi-channel signal, the level correcting unit 414 does not execute the level correction. The output signals Loc4 and Roc4 after the level correction are supplied to the D/A converter 415 and the transmission modulation unit 416, respectively.

The D/A converter 415 is connected to the speakers via the amplifier (not shown), and the surround headphone output signals Loc4 and Roc4 are reproduced. In addition, the transmission modulation unit 416 is the modulating unit of the digital audio data transmitted to the wireless headphones, and the modulated signal is transmitted to the wireless headphones (not shown). As the transmission modulation, FM modulation and predetermined digital modulation can be used, for example.

The output channel displaying unit 417 visually displays an output channel state of the surround headphone output signals presently outputted. Concretely, the microprocessor 413 supplies, to the output channel displaying unit 417, the output channel information Sc401 obtained from the multi-channel decoder 411 as a control signal Sc403. Based on the control signal Sc403, the output channel displaying unit 417 displays, on the display panel, whether the surround headphone output signal presently outputted is the monophonic signal, the stereo signal or the multi-channel. Thereby, the user using the headphones can know whether the signal to which he or she is presently listening is the monophonic signal, the stereo signal or the multi-channel signal.

As described above, the virtual surround decoder apparatus includes the multi-channel decoder 411 outputting the source signal of the kinds including the multi-channel based on the input source signal, the stereo downmix processor 412 generating the surround headphone output signals from the source signals outputted from the multi-channel decoder 411, the determining unit determining the kind of the source signal outputted from the multi-channel decoder 411, and the correction level correcting unit 414 correcting the level of the surround headphone output signals based on the determined result. Hence, when the source signal supplied to the stereo downmix processor 412 from the multi-channel decoder 411 is the monophonic signal or the stereo signal, it can be prevented that the S/Ns of the surround headphone output signals Lo4 and Ro4 problematically decrease due to the attenuation process of the stereo downmix processor 412. Additionally, since the S/Ns of the surround headphone output signals Lo4 and Ro4 are ensured, the S/N in the transmission process to the wireless headphones from the transmission modulation unit 416 can be also ensured.

(Modification)

If the stereo downmix method by the stereo downmix processor 412 includes the Dolby headphone process, since a level of a specific frequency is varied, the level correction amount by the level correcting unit 414 may be varied by the amount.

In addition, in the above-mentioned example, the correction amount of the same level is used even when the input source signal is the monophonic signal or the stereo signal. However, the level correction amount may be different between cases in which the input source signal is the monophonic signal and the stereo signal.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Applications No. 2005-141825 and No. 2005-141828 filed on May 13, 2005 including the specifications, claims, drawings and summaries is incorporated herein by reference in its entirety.

What is claimed is:

1. A virtual surround decoder apparatus comprising:
a matrix surround decoder which generates multi-channel source signals from 2-channel input source signals;
a virtual surround decoder which generates virtual surround signals from the multi-channel source signals; and
a level correcting unit which corrects levels of the virtual surround signals.

2. The virtual surround decoder apparatus according to claim 1,
wherein the matrix surround decoder includes: an attenuation processing unit which attenuates the 2-channel input source signals by a predetermined level; and an operating unit which executes a matrix operation of the 2-channel input source signals after the attenuation process to generate the multi-channel source signals, and
wherein the level correcting unit increases the levels of the virtual surround signals by the predetermined level.

3. A virtual surround decoder apparatus comprising:
a multi-channel decoder which outputs one or more source signal of one of a plural kinds including multi-channel signal, based on an input source signal;
a virtual surround decoder which generates virtual surround signals from the source signal outputted from the multi-channel decoder;
a determining unit which determines the kind of the source signal outputted from the multi-channel decoder; and
a level correcting unit which corrects the level of the virtual surround signals based on a determination result by the determining unit.

4. The virtual surround decoder apparatus according to claim 3,
wherein the determining unit determines whether the source signal outputted from the multi-channel decoder is monophonic signals, stereo signals or multi-channel signals, and
wherein the level correcting unit executes level correction when the source signal outputted from the multi-channel decoder is the monophonic signals or the stereo signals.

5. The virtual surround decoder apparatus according to claim 4,
wherein the virtual surround decoder includes: an attenuation processing unit which attenuates the source signal outputted from the multi-channel decoder by a predetermined attenuation level; and a synthesizing unit which synthesizes the attenuated source signal to generate the virtual surround signals, and
wherein the level correcting unit executes correction of increasing the level of the virtual surrounds signals by a correction level corresponding to the predetermined attenuation level.

6. The virtual surround decoder apparatus according to claim 5, wherein the correction level is equal to the predetermined attenuation level.
